(19) United States
(12) Patent Application Publication
(10) Pub. No.: US 2014/0376257 A1
(43) Pub. Date: Dec. 25, 2014

(54) OPERATING PANEL AND INFORMATION APPARATUS PROVIDED WITH SAME

(71) Applicants: Shuji Sawada, Tokyo (JP); Keita Tonoike, Tokyo (JP)

(72) Inventors: Shuji Sawada, Tokyo (JP); Keita Tonoike, Tokyo (JP)

(73) Assignee: Mitsubishi Electric Corporation, Tokyo (JP)

(21) Appl. No.: 14/370,513

(22) PCT Filed: Apr. 18, 2012
(86) PCT No.: PCT/JP2012/002662

§ 371 Date: Jul. 3, 2014

(51) Int. Cl. F21V 8/00

(52) U.S. Cl. CPC G02B 6/005; F21W 2121/00
USPC 362/606

(57) ABSTRACT

There is provided with a light transmissive substrate 4 that is a touch panel or a display panel, a decoration part 3c formed such that a light shielding print layer that shields light transmitted from a rear side to a front side of the light transmissive substrate 4 is removed in a shape of a character or symbol, a light source 6 provided at the rear side of the light transmissive substrate 4, and a dark color light guide member 8 that is arranged between the light source 6 and the decoration part 3c, and that guides light irradiated from the light source 6 to the decoration part 3c.

### TECHNICAL FIELD

The present invention relates to an operating panel for use in an in-vehicle information apparatus or the like, and to an information apparatus provided with the same.

### BACKGROUND ART

Conventionally, for an operating panel of an in-vehicle information apparatus or the like, there is the one such that characters or symbols indicating functions of operating keys are irradiated and displayed on a front surface thereof such that a rear surface thereof is irradiated by light from a light source.

In addition, there is also an operating panel adapted such that light from a light source is irradiated to a rear surface thereof through a dark color layer. In this operating panel, when illuminated, characters or symbols are illuminated and displayed, whereas when not illuminated, the characters or symbols are displayed in a dark color (see Patent Document 1)

### PRIOR ART DOCUMENTS

### Patent Documents

Patent Document 1: Japanese Patent Application Laid-open No. 2005-77874

### SUMMARY OF THE INVENTION

### Problems to be Solved by the Invention

In a conventional technique represented by Patent Document 1, a dark color layer is provided as follows: a decoration part is formed such that a light shielding layer provided on a light transmissive substrate such as a touch panel (touchscreen) or a display panel is removed in the shape of characters or symbols, and a dark color sheet is stuck to the decoration part, or a dark color printing is applied thereto.

As mentioned above, in the configuration where the dark color sheet is stuck to the decoration part formed on the light transmissive substrate, or the dark color printing is applied thereto, if there occurs a misalignment at a stuck position of the dark color sheet, when the light transmissive substrate is assembled as an operating panel, the dark color sheet may be caught between other members, or wrinkled. In addition, if there occurs a deviation in the dark color printing, there will be unevenness in a dark color part. In these cases, because there are variations in the condition of the dark color layer directly formed on the decoration part, design of the decoration part or visibility of the characters or symbols thereof is highly likely to be deteriorated.

For this reason, in the conventional, a severe tolerance is required in a process of sticking the dark color sheet to the decoration part formed on the touch panel or display panel, or a process of applying the dark color printing thereto, resulting in a decrease in yield of the touch panel or display panel.

The present invention is made to solve the foregoing problems, and an object of the invention is to provide an operating panel that is hardly affected by variations in manufacturing, and an information apparatus having the same.

### Means for Solving the Problems

An operating panel according to the invention includes: a light transmissive substrate; a decoration part formed such that a light shielding layer that shields light transmitted from a rear side to a front side of the light transmissive substrate is removed in a shape of a character or symbol; a light source provided at the rear side of the light transmissive substrate; and a dark color light guide member, arranged between the light source and the decoration part, for guiding light irradiated from the light source to the decoration part.

### Effect of the Invention

According to the invention, there is an advantageous effect that can provide an operating panel that is hardly affected by variations in manufacturing.

### BRIEF DESCRIPTION OF THE DRAWINGS

FIG. 1 is a front view illustrating an information apparatus provided with an operating panel according to the present invention.

FIG. 2 is an exploded perspective view illustrating a configuration of the information apparatus according to Embodiment 1 of the invention.

FIG. 3 is a cross-sectional view of the operating panel according to Embodiment 1.

FIG. 4 is a cross-sectional view of an operating panel according to Embodiment 2 of the invention.

FIG. 5 is a cross-sectional view of an operating panel according to Embodiment 3 of the invention.

### BEST MODE FOR CARRYING OUT THE INVENTION

In the following, in order to describe the present invention in more detail, embodiments for carrying out the invention will be described with reference to the accompanying drawings.

### Embodiment 1

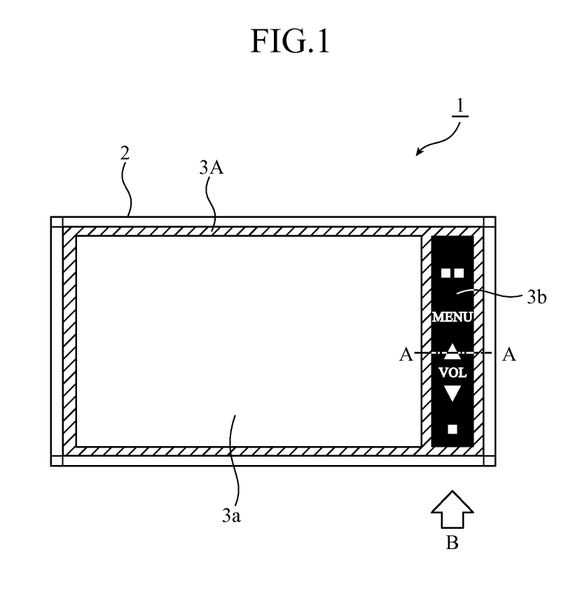

FIG. 1 is a front view illustrating an information apparatus provided with an operating panel according to the invention. An information apparatus 1 in FIG. 1 shows a display device incorporated in an instrument panel of a vehicle, or a portable information device such as a PND (Portable Navigation Device) having a liquid crystal display part. In a front side case 2 of the information apparatus 1, a light transmissive (translucent) substrate part 3A is mounted on the side of a display surface of an inner liquid crystal display panel. The light transmissive substrate part 3A is composed of a touch panel, a display panel, and the like. On the front side of the light transmissive substrate part 3A to be exposed to the outside, as shown in FIG. 1, formed are a display area 3aserving as the display surface, and a decorative area 3b for displaying a decoration part containing characters and symbols that indicate functions of operating keys. The operating panel according to the invention is the one having the above decorative area 3b.

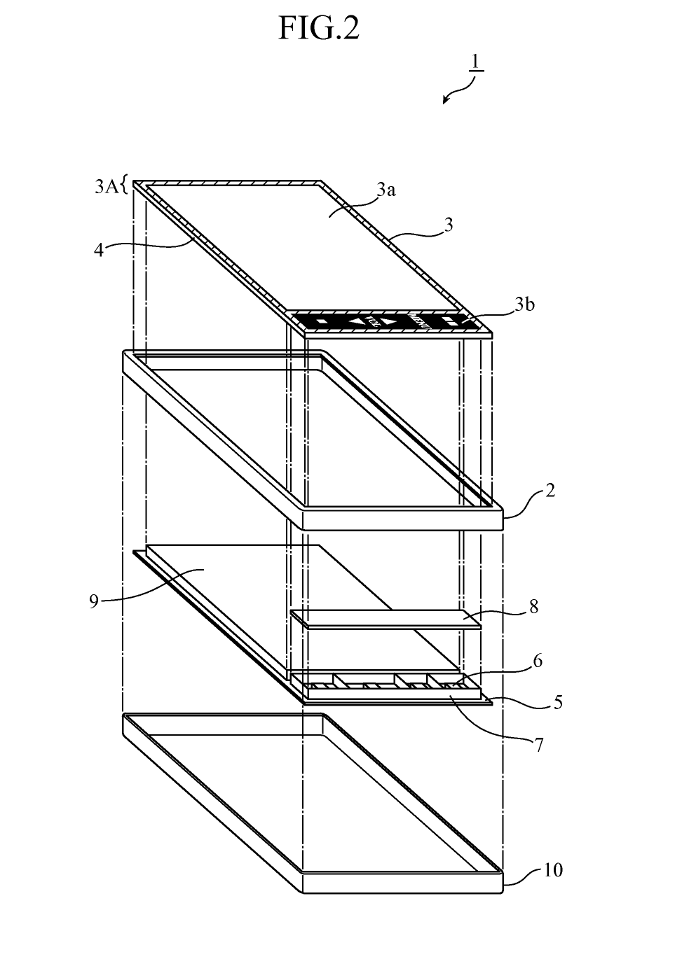

FIG. 2 is an exploded perspective view illustrating a configuration of the information apparatus according to Embodiment 1 of the invention, and shows a schematic configuration of the information apparatus 1 in FIG. 1. In the information apparatus 1 shown in FIG. 2, the light transmissive substrate part 3A is attached on an opening of the front side case 2; a circuit substrate 5, a light source 6, a holder 7, a dark color light guide member 8, and an liquid crystal display panel 9 are housed in an apparatus casing constituted of the front side case 2 and a rear side case 10.

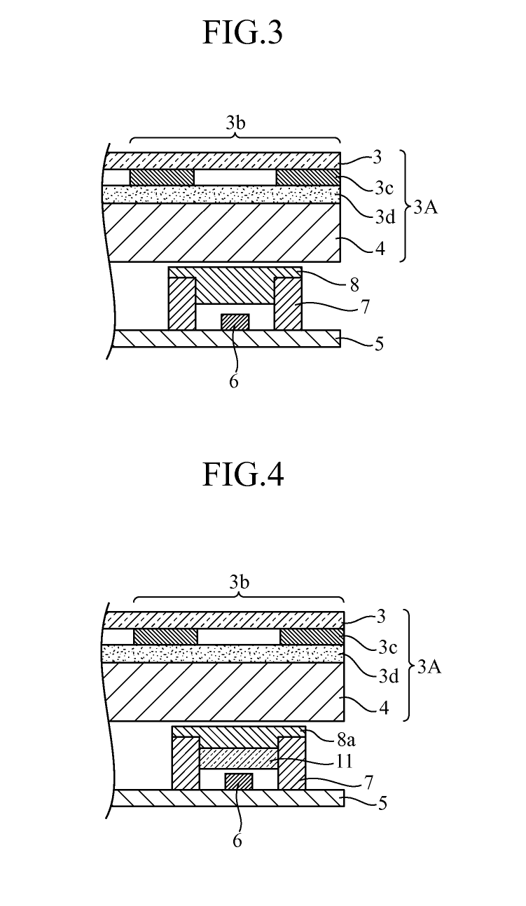

The light transmissive substrate part 3A is formed by laminating a transparent film 3 to a light transmissive substrate 4, and attached thereto as follows: for example, a surface thereof is substantially flush with an opening plane of the front side case 2. The transparent film 3 is the film stuck on the surface of the light transmissive substrate 4, and as described later in FIG. 3, a light shielding printing is applied to a region adjacent the display area 3a to thus form the decoration part. The light transmissive substrate 4 is composed of a touch panel or a transparent resin display panel, and has a function that protects the display surface of the liquid crystal display panel 9 from a touching operation, external impact, and so on.

The circuit substrate 5 is the substrate on which internal components of the information apparatus 1 are mounted, and the light source 6 that irradiates light from the rear side of the light transmissive substrate 4 toward the decorative area 3b is mounted thereon. The light source 6 is the light source such as an LED element provided for illuminating the decoration part. The holder 7 is the holder formed of a wall provided around the light source 6, and shields the light irradiated from the light source 6 to prevent it from leaking to the liquid crystal display panel 9 side. Note that in order to prevent interference of light between the light sources 6 that illuminate the characters or symbols for each function of the operating keys, the holder 7 has a wall that separate between the light sources 6 as shown in FIG. 2.

The dark color light guide member 8 is arranged between the light source 6 and the decoration part, and is the guide member such as a prism that guides the light irradiated from the light source 6 to the decoration part.

The liquid crystal display panel 5 includes a liquid crystal layer, an electrode structure that applies an electric field to the liquid crystal layer, a color filter, a polarizing plate, and a backlight member that irradiates a backlight beam from the rear side.

In addition, FIG. 3 is a cross-sectional view of the operating panel according to Embodiment 1, and shows a cross section cut along a line A-A in FIG. 1 viewed from the direction of an arrow B. In FIG. 3, the transparent film 3 is stuck on the surface of the light transmissive substrate 4 via an adhesive layer 3d. A region of the transparent film 3 corresponding to the decorative area 3b is applied with a rear surface printing of an opaque (non-transmissive) color (for example, black), and the decoration part 3c is formed by removing this print layer (light shielding layer) in the shape of at least one of the characters and symbols indicating predetermined functions of the operating keys.

Moreover, in the operating panel shown in FIG. 3, the dark color light guide member 8 is arranged on the light source 6 side (rear side) of the light transmissive substrate 4. Specifically, the dark color light guide member 8 is secured to the opening of the holder 7, and the holder 7 is secured to the circuit substrate 5 or other components so as to surround the light sources 6. In this manner, the dark color light guide member 8 is arranged so as to cover light irradiation part of the light source 6, so that the light irradiated from the light source 6 is guided toward the decoration part 3c via the dark color light guide member 8.

When illuminated, the light irradiated from the light source 6 is emitted toward the front surface of the transparent film 3 via the dark color light guide member 8 through a part of the decoration part 3c (part of the characters or symbols) where the light shielding printing layer is removed. In this manner, the characters or symbols of the decoration part 3c are illuminated and displayed.

On the other hand, when not illuminated, a dark color of the light guide member 8 appears through the part of the decoration part 3c where the light shielding print layer is removed, and thus no inside of the apparatus housing is seen through, thereby maintaining the design of the decoration part 3c.

As mentioned above, it can be configured by simply attaching the dark color light guide member 8 thereon; thus, there is no need to stick a dark color sheet to the decoration part or apply a dark color printing thereto unlike the conventional, and the panel is not easily affected by variations in manufacturing. Moreover, display/non-display of the characters or symbols of the decoration part 3c can be switched in response to presence or absence of the illumination, and thus an operating panel excellent in design can be provided.

Additionally, although in the example of FIG. 3, there is shown the configuration where the decoration part 3c is formed by applying the light shielding printing to the transparent film 3, the decoration part 3c may be directly formed in the light transmissive substrate 4 that is the touch panel or display panel.

While there is shown the configuration in which the dark color light guide member 8 is secured to the holder 7 in FIG. 3, the holder 7 and light guide member 8 may be integrally formed. With such a configuration, the structure can become simpler, and the number of components can be reduced. In this case, it may be formed by two-color molding with the holder 7 made of an opaque color material and the light guide member 8 made of a dark color material. Alternatively, the whole integrated structure of the holder 7 and light guide member 8 may be formed of a dark color material, and then an opaque color layer (for example, an opaque color print layer) may be provided therearound.

Additionally, while there is shown in FIG. 3 the configuration in which the dark color light guide member 8 is arranged on the light source 6 side (rear side) of the light transmissive substrate 4, it may be arranged on the decoration part 3c side (front side) of the light transmissive substrate 4.

In such a configuration, the dark color light guide member 8 will be located closer in the depth direction to the decoration part 3c, and thus covers the inside more reliably to prevent it from seeing through the part of the decoration part 3c where the light shielding print layer is removed as compared to the configuration shown in FIG. 3, whereby the design of the decoration part 3c is enhanced.

Incidentally, although in this configuration an additional process to the light transmissive substrate 4 is required, the dark color light guide member 8 is merely attached thereon to be thus hardly affected by variations in manufacturing, unlike the conventional case in which the dark color sheet is stuck thereto, or the dark color printing is applied thereto.

Furthermore, an adhesive or a double-sided tape of a light shielding color may be used for the adhesive layer 3d corresponding to the decorative area 3b to form the decoration part 3c, whereby a light shielding printing on the transparent film 3 or a decoration on the light transmissive substrate 4 can be omitted.

In the operating panel according to the present invention, the light transmissive substrate 4, not limited to the touch panel, may be a transparent protective plate for display. Incidentally, a glass or resin protective plate is inexpensive; thus, in many cases, the manufacturing cost is suppressed at low cost in the following manner: the dark color sheet is directly stuck on the decoration part of the protective plate, or the dark color printing is applied thereto, and then the one with better precision is selected.

However, when the light transmissive substrate 4 is a component added with expensive functions such as the touch panel, the manufacturing cost is greatly influenced by a decrease in yield of the light transmissive substrate 4. For this reason, there is a great advantage for the cost by application of the structure according to the present invention.

As described above, according to Embodiment 1, the operating panel includes: the light transmissive substrate 4 that is the touch panel or display panel; the decoration part 3c formed such that the light shielding print layer that shields the light transmitted from the rear side to the front side of the light transmissive substrate 4 is removed in the shape of the characters or symbols; the light source 6 provided at the rear side of the light transmissive substrate 4; and the dark color light guide member 8 that is arranged between the light source 6 and decoration part 3c, and that guides the light irradiated from the light source 6 to the decoration part 3c. With this configuration, an operating panel that is hardly affected by variations in manufacturing can be provided with maintaining the visibility and design of the decoration part 3c.

In addition, according to Embodiment 1, the operating panel includes the holder 7, formed by the wall around the light source 6, for shielding the light irradiated from the light source 6, and the dark color light guide member 8 is arranged on the holder 7 so as to cover the light irradiation part side of the light source 6. With this configuration, an additional process to the decoration part 3c of the light transmissive substrate 4 is eliminated, and thus an improvement in yield of the light transmissive substrate 4 such as the touch panel or display panel can be expected.

### Embodiment 2

FIG. 4 is a cross-sectional view of an operating panel according to Embodiment 2 of the present invention, and shows a cross section of an information apparatus according to Embodiment 2 cut along the line A-A in FIG. 1 when viewed from the direction of the arrow B. The operating panel shown in FIG. 4 includes a dark color light guide member 8a formed with a transparent light guide member 11 that is transparent in a part to be transmitted by light irradiated from a light source 6, instead of the dark color light guide member 8 shown in FIG. 3.

The light guide member 8a is secured to an opening of a holder 7 similarly to that in Embodiment 1, and light irradiated from the light source 6 is guided toward a decoration part 3c through the transparent light guide member 11 and dark color light guide member 8a.

In this connection, the light guide member 8a and light guide member 11 may be constituted as another component by sticking these members to each other, and the dark color light guide member 8 and the transparent light guide member 11 is integrally formed by two-color molding. Additionally, though the transparent light guide member 11, as shown in FIG. 4, may be formed on the light source 6 side of the dark color light guide member 8, any part to be transmitted by the light irradiated from the light source 6 may be formed on the decoration part 3c side.

According to Embodiment 2, as described above, the dark color light guide member 8a is formed with the transparent light guide member 11 having the part to be transmitted by the light irradiated from the light source 6, and thus the luminance of the light to illuminate and display the characters or symbols of the decoration part 3c can be made higher as compared to the configuration shown in Embodiment 1.

### Embodiment 3

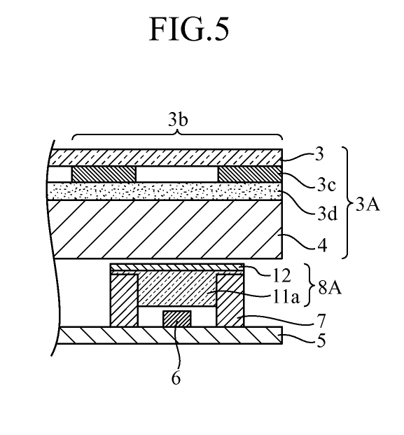

FIG. 5 is a cross-sectional view of an operating panel according to Embodiment 3 of the present invention, and shows a cross section of an information apparatus according to Embodiment 3 cut along the line A-A in FIG. 1 when viewed from the direction of the arrow B. The operating panel shown in FIG. 5 includes a dark color light guide member 8A constituted of a transparent light guide member 11a formed with a dark color layer (for example, dark color sheet or dark color print) 12 with respect to a part to be transmitted by light irradiated from a light source 6, instead of the dark color light guide member 8 shown in FIG. 3.

The dark color light guide member 8A is secured to the opening of a holder 7 similarly to that in Embodiment 1, and the light irradiated from the light source 6 is guided toward a decoration part 3c through the transparent light guide member 11a and a dark color layer 12.

In this connection, though there is shown in FIG. 5 a case where the dark color layer 12 is formed on the decoration part 3c side (front side) of the transparent light guide member 11a, the dark color layer 12 may be formed on the light source 6 side (rear side).

Additionally, in Embodiment 3, the part of the transparent light guide member 11a to be transmitted by the light irradiated from the light source 6 has only to be the dark color layer 12. The light guide member 11a and dark color layer 12 may be formed integrally such that the dark color layer 12 is an intermediate layer of the transparent light guide member 11a.

As described above, according to Embodiment 3, the dark color light guide member 8A includes the transparent light guide member 11a having the dark color layer 12 formed in the part to be transmitted by the light irradiated from the light source 6, and thus the luminance of the light to illuminate and display the characters or symbols of the decoration part 3c can be made even higher, as compared to the configurations shown in the above Embodiments 1 and 2.

It is noted that in the present invention, the embodiments may be freely combined, or any given constituent element of each embodiment may be modified, or any given constituent element in each embodiment may be omitted within the scope of the invention.

### INDUSTRIAL APPLICABILITY

Because the operating panel according to the present invention is hardly affected by variations in manufacturing, it is suitably for use in an operating panel of an in-vehicle information apparatus, a mobile information apparatus, or the like.

### DESCRIPTION OF REFERENCE NUMERALS

1: information apparatus

2: front side case

3: transparent film

3A: light transmissive substrate part

3a: display area

3b: decorative area

3c: decoration part

3d: adhesive layer

4: light transmissive: substrate

5: circuit substrate

6: light source

7: bolder

8, 8a, 8A: dark color light, guide members

9: liquid crystal display panel

10: rear side case

11, 11a: transparent light guide members

12: dark color layer.

1. An operating panel, comprising:
a light transmissive substrate;
a decoration part formed such that a light shielding layer that shields light transmitted from a rear side to a front side of the light transmissive substrate is removed in a shape of a character or symbol;
a light source provided at the rear side of the light transmissive substrate; and
a dark color light guide member that is arranged between the light source and the decoration part, and that guides light irradiated from the light source to the decoration part.

2. The operating panel according to claim 1, wherein the dark color light guide member is formed of a transparent light guide member having a part to be transmitted by the light irradiated from the light source.

3. The operating panel according to claim 1, wherein the dark color light guide member is a transparent light guide member having a dark color layer formed in a part to be transmitted by the light irradiated from the light source.

4. The operating panel according to claim 1, further comprising a holder that is constituted of a wall provided around the light source, and that shields the light irradiated from the light source, wherein
the dark color light guide member is arranged on the holder so as to cover a light irradiation part side of the light source.

5. An information apparatus comprising the operating panel according to claim 1.
